(19) United States
(12) Patent Application Publication
(10) Pub. No.: US 2013/0317397 A1
(43) Pub. Date: Nov. 28, 2013

(54) Device and Method Against Effects of Bruxism

(71) Applicant: Tellier Onno Jan, Soesterberg (NL)

(72) Inventor: Tellier Onno Jan, Soesterberg (NL)

(73) Assignee: ENDEAVOR YACHTS B.V., Wormer (NL)

(21) Appl. No.: 13/805,903

(22) PCT Filed: Jun. 21, 2011
(86) PCT No.: PCT/NL11/50448

§ 371 Date: Aug. 15, 2013

(30) Foreign Application Priority Data
Jun. 21, 2010 (NL) 2004934

(51) Int. Cl. A61H 1/02

(52) U.S. Cl. CPC A61H 1/0218
USPC 601/38

(57) ABSTRACT

The present invention relates to a device for treating bruxism, wherein the device comprises: a lower engaging member with a stimulus surface directed substantially downward during use for providing an engagement on a lower jaw element or the teeth thereof during performing of the treatment; an upper engaging member with a stimulus surface directed substantially upward during use for providing an engagement on an upper jaw element or the teeth thereof during performing of the treatment; a mechanism connecting the lower engaging member and the upper engaging member for providing a mutual connection between the engaging members, and a drive mechanism for moving apart at least parts of the engaging members by means of a driving for the purpose of forcing apart the lower jaw element and the upper jaw element, thereby achieving that at least the muscles of mastication are exposed to an activation stimulus.

The present invention relates to a device for treating bruxism, or at least for providing a technical aid for the purpose of this treatment. The present invention also relates to a method for performing a treatment for the purpose of providing a relaxed expression by providing an activation stimulus to a facial muscle.

Bruxism is a form of behaviour wherein an increased muscle tension occurs, particularly in the muscles of mastication on either side of the face. This creates a strained expression of the person displaying this behaviour. The present invention aims to realize a reduction in the optical effect of this muscle tension caused by this behaviour.

In addition to the stated behaviour problems associated with bruxism, it is also known that people can suffer from disorders causing an inability to open the jaw sufficiently for a normal action of the jaw. Such disorders, known as trismus, can be caused for instance by rheumatic disorders, arthritis, cancer or serious accidents. A splint from Dynasplint Inc. is known for providing such patients with the possibility of normally opening the mouth again. Such complex systems have a field of application essentially other than the present invention.

It is for instance known that a greater measure of relaxation can be achieved by giving a relaxation massage around the jaw and shoulder area, whereby the person who would be helped by the present invention can acquire a more friendly expression. However, this requires an expert massage and can in any case not be carried out independently by the person in question.

In order to provide a solution which can be applied independently by a person in overcoming the undesirable behaviour, the present invention provides a device for treating bruxism, or at least for providing assistance during the treatment, wherein the device comprises:
a lower engaging member with a stimulus surface directed substantially downward during use for providing an engagement on a lower jaw element or the teeth thereof during performing of the treatment;
an upper engaging member with a stimulus surface directed substantially upward during use for providing an engagement on an upper jaw element or the teeth thereof during performing of the treatment;
a mechanism connecting the lower engaging member and the upper engaging member for providing a mutual connection between the engaging members, and a drive mechanism for moving apart at least parts of the engaging members by means of a driving for the purpose of forcing apart the lower jaw element and the upper jaw element, thereby achieving that at least the muscles of mastication are exposed to an activation stimulus.

Applying the activation stimulus realizes that particularly the muscles of mastication of the face receive a stimulus of the surface which is opposed to the behaviour stimulus leading to clenching of the jaws and resulting in the jaws being held tensioned in clenched position and the consequent visible muscle tension in the face.

In a first preferred embodiment the relative orientation during the movement of moving apart the engaging members is such that the engaging members are directly removable from the mouth in this relative orientation to each other. This prevents the device becoming clamped in the mouth, for instance due to cramp, and always being removable despite this. The device according to the present invention is safe under all conditions during use.

The relative orientation during the movement of moving apart the engaging members is more preferably such that the respective stimulus surfaces are always arranged at an angle such that imaginary lines extending from the stimulus surfaces would intersect each other behind the person, or that these imaginary lines have a parallel progression. Realized hereby in practical manner is that the device can be removed from the mouth under all circumstances.

A variant for realizing a parallel arrangement of the stimulus surfaces comprises the measure that the connecting mechanism is adapted for a linear movement of the engaging members relative to each other. A safe limit value for enabling removal of the engaging members from the mouth is hereby realized.

In a further preferred embodiment the connecting mechanism is adapted for a pivoting movement of the engaging members relative to each other. Variants which are even simpler to remove than in the previous preferred embodiment can be realized by means of such a preferred embodiment. Even in the case of a very soft embodiment of the stimulus surfaces it is hereby made possible for the engaging members to be removed in simple manner from the mouth in the case for instance that a cramp situation occurs.

A variant hereof is the situation where the connecting mechanism is provided with a hinge arranged during use on the front side of the head of the user. It is recommended here that the activation surfaces remain directed toward each other while the treatments are performed.

The intended effect of the direction of the activation surfaces is achieved in alternative manner by means of a connecting mechanism provided with one or more hinges defining a rotation axis of a hinge substantially close to the pivot axis of the maxillary joint of the user. It is recommended here that a hinge is arranged on either side of the face substantially close to the maxillary joint and that the mechanism is adapted such that the engaging members can be placed in the mouth with the activation surfaces pointing toward each other.

In order to enable safe removal in any operating position, the upper stimulus surface has an inclining surface directed substantially downward during use and/or the lower stimulus surface has an inclining surface directed substantially upward during use. An alternative method is hereby provided for enabling safe removal from the mouth.

For the purpose of protecting the teeth the stimulus surface comprises a material which does not affect the teeth, such as a material which is less hard than the teeth, preferably a soft plastic material or a soft rubber material. This imparts a further degree of safety to the device for performing the method. The load can hereby be applied to a relatively small number of teeth, elements and/or alveolar ridge while the effectiveness is maintained. The device can hereby be given a relatively small form and be applied in effective manner. A small variant can be placed in multiple positions in the mouth.

A simple preferred variant of the connecting mechanism is provided with a drive by means of a screw thread. An increasing force can hereby be applied in controlled manner to the engaging members and the activation surfaces. As this increasing force is being caused, direct feedback is provided to the person who is increasing the force in that this person him/herself feels how the very gradually developing mutual distance between the activation surfaces exerts influence on the relevant facial muscle and the jaw.

Alternatives to the described embodiment of the connecting mechanism comprise a pneumatic or hydraulic drive, more preferably by means of a drive with an electric motor. The person need hereby not use any further muscle power to increase the operative forces. In alternative manner an air pump or liquid pump with manual drive can be applied. A simple squeeze pump is envisaged here.

In an alternative preferred embodiment the device comprises a measuring assembly for providing measurement data relating to the mutual distance between the stimulus surfaces, which measuring assembly is preferably optically readable and which measuring assembly more preferably comprises electronic and/or optical measuring means which can be given a digital form. It hereby becomes possible for the user to be provided with a quantitative feedback relating to the obtained results. Practical measuring instruments which are per se known for this purpose achieve in effective manner a measurement accuracy which can in practice surpass the adjustable accuracy of even a fine screw thread. It hereby becomes practically possible to record any performable operation as a measurement and therefore convert it to a suitable feedback. It is for instance possible to perform a measurement relating to the linear displacement of the engaging members relative to each other.

In order to further increase safety the device more preferably comprises means for providing a visual and/or auditive signal relating to the mutual distance between the stimulus surfaces, such as a limit value thereof, to the user. It hereby becomes possible for the user to have the device provide feedbacks within tolerances which are safe for the user, so that the user need not rely only on a sensation of muscle tension and/or pain, but can also rely on measurement data.

The device preferably comprises a stop adjustable prior to the treatment. The stop is more preferably formed by two screw elements.

In a further preferred embodiment the device comprises a measuring member for measuring the force exerted by the stimulus surfaces on the upper jaw and the lower jaw. An alternative measurement value is hereby provided in effective manner for the purpose of further safeguarding the device so as to prevent damage to tissue of the body of the person.

In a further preferred embodiment the device comprises a masking member for masking the opening of the mouth during use thereof.

More preferably provided is an embodiment comprising means for coupling the device to the ears of the treated person.

A further aspect according to the present invention relates to a method for performing a treatment for the purpose of providing a relaxed expression by providing an activation stimulus to a facial muscle making use of a device according to one or more of the foregoing claims, wherein the method comprises steps for:
placing the stimulus surfaces at a relatively small mutual distance between the lower jaw and the upper jaw;
activating the connecting mechanism in order to increase the mutual distance between the stimulus surfaces;
maintaining for a short period of time the mutual distance obtained through the activation;
activating the connecting mechanism in order to decrease the mutual distance between the stimulus surfaces. It becomes possible by means of such a method to soften the expression and the appearance of the person in cosmetic manner, whereby the person can make a more pleasant impression in his/her daily environment.

Repetition of these steps is important in order to gradually achieve a desired result.

Further advantages, features and details of the present invention will be described in greater detail hereinbelow on the basis of one or more preferred embodiments with reference to the accompanying figures.

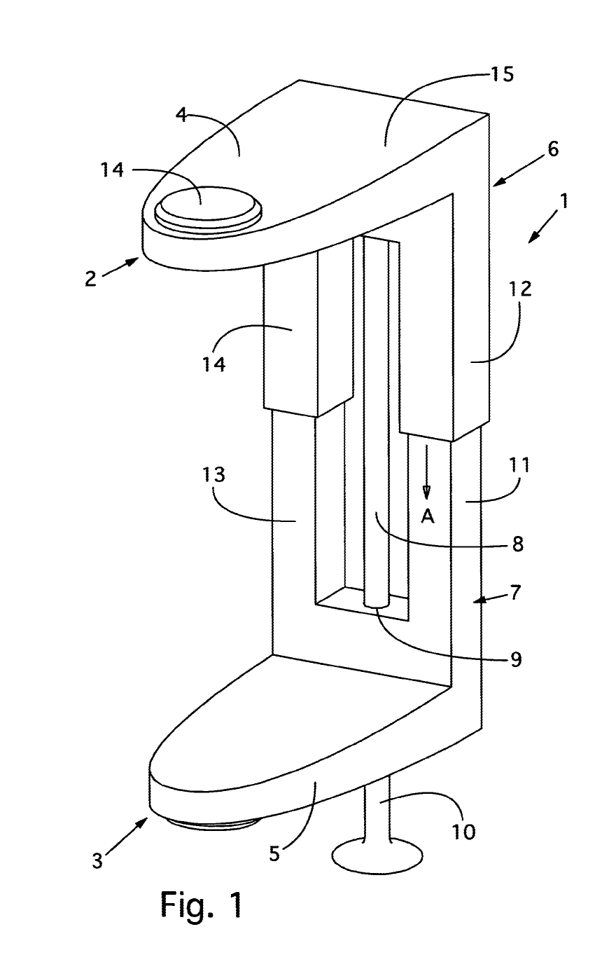

FIG. 1 shows a first preferred embodiment according to the present invention.

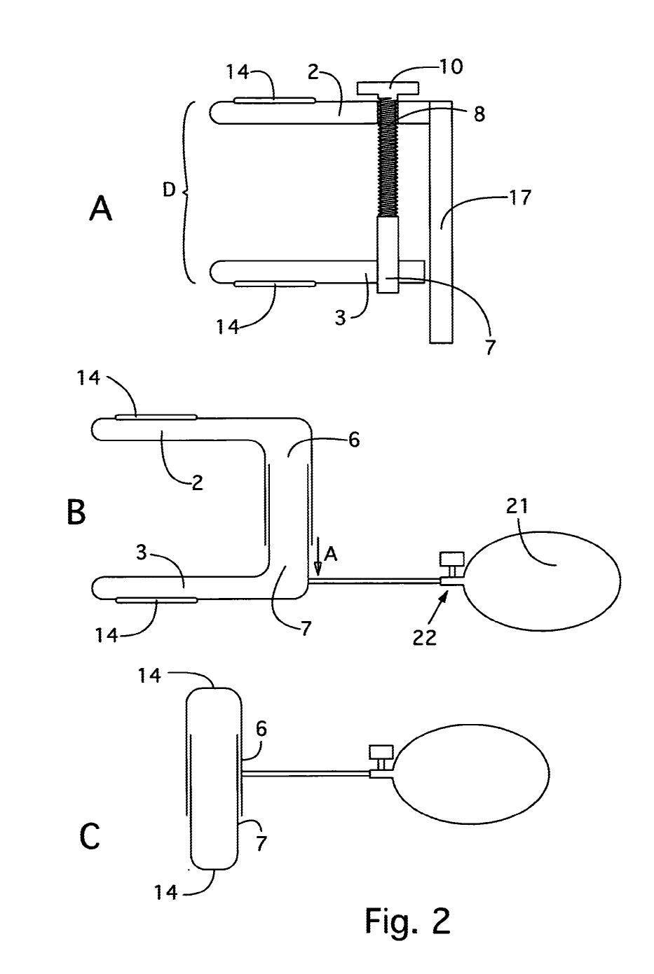

FIG. 2 shows a further preferred embodiment according to the present invention.

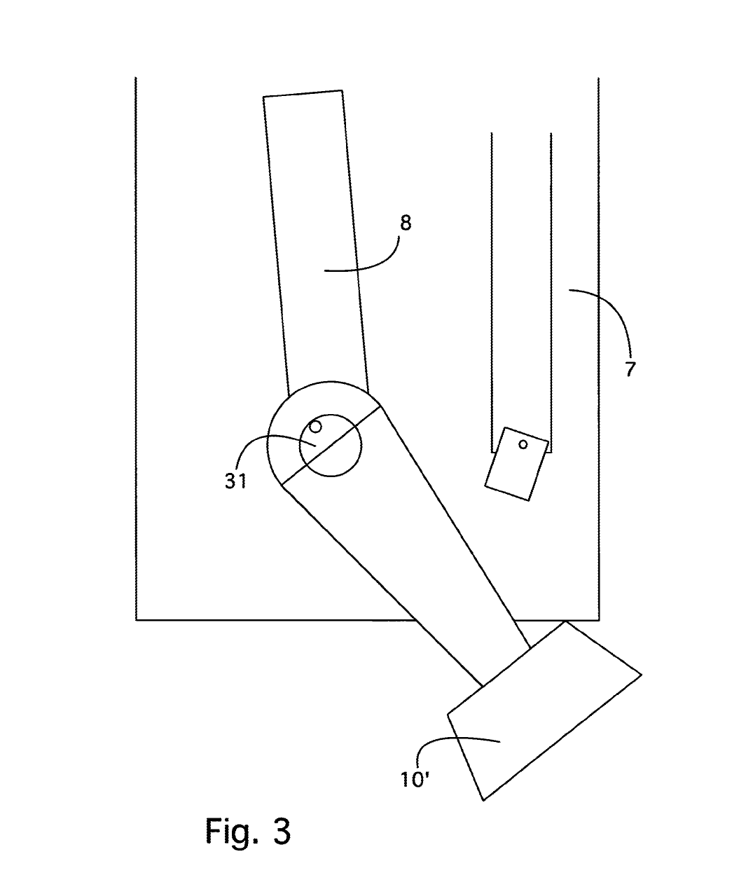

FIG. 3 shows a further preferred embodiment according to the present invention.

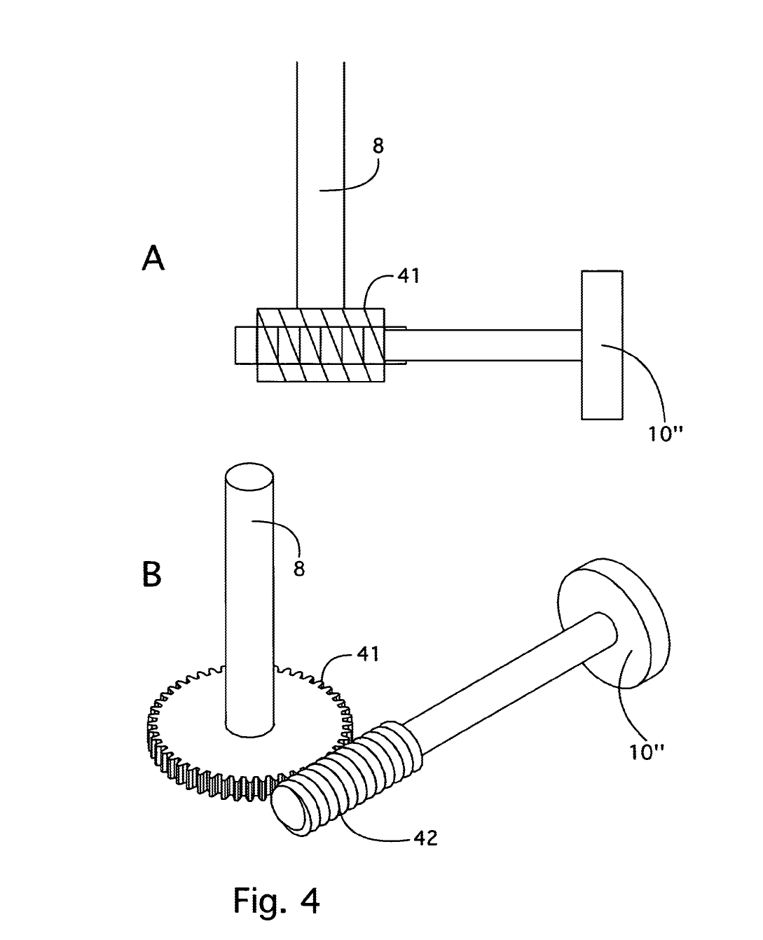

FIG. 4 shows a further preferred embodiment according to the present invention.

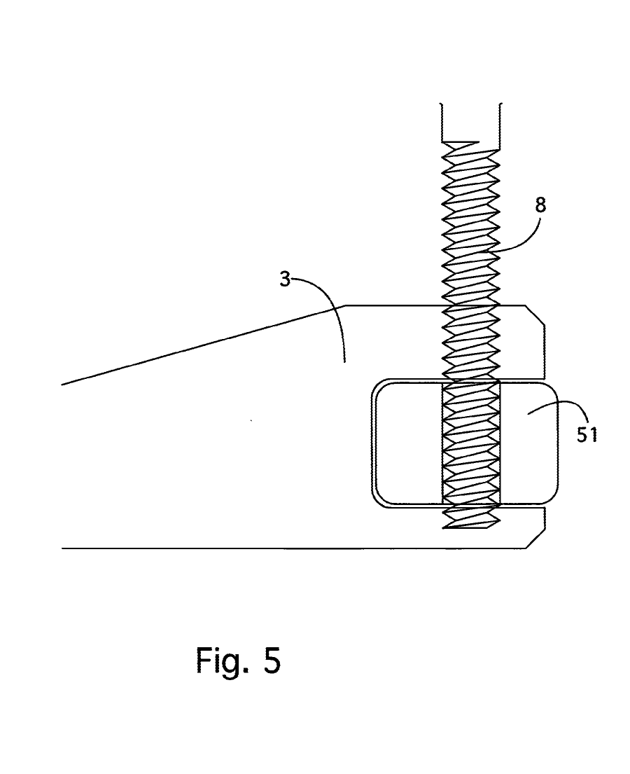

FIG. 5 shows a further preferred embodiment according to the present invention.

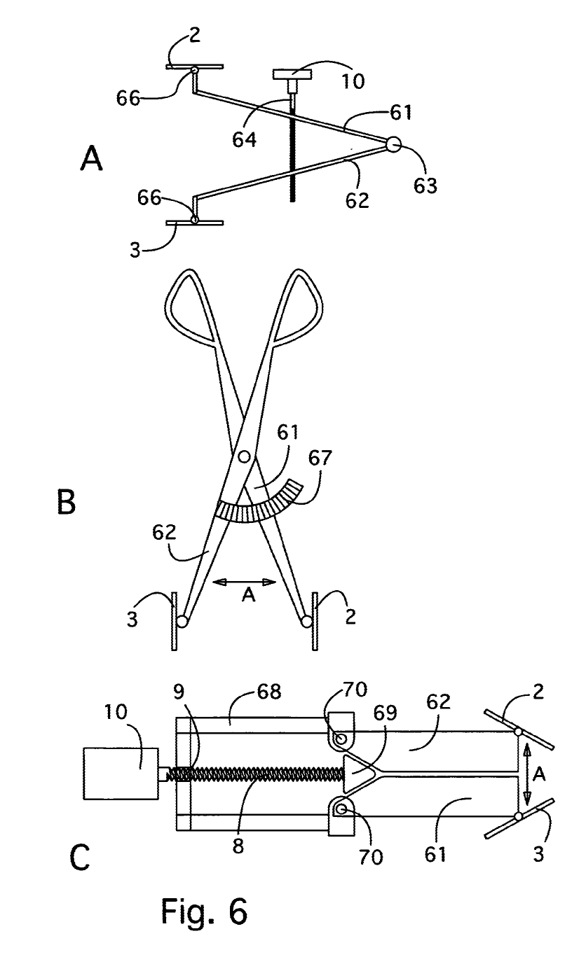

FIG. 6 shows a further preferred embodiment according to the present invention.

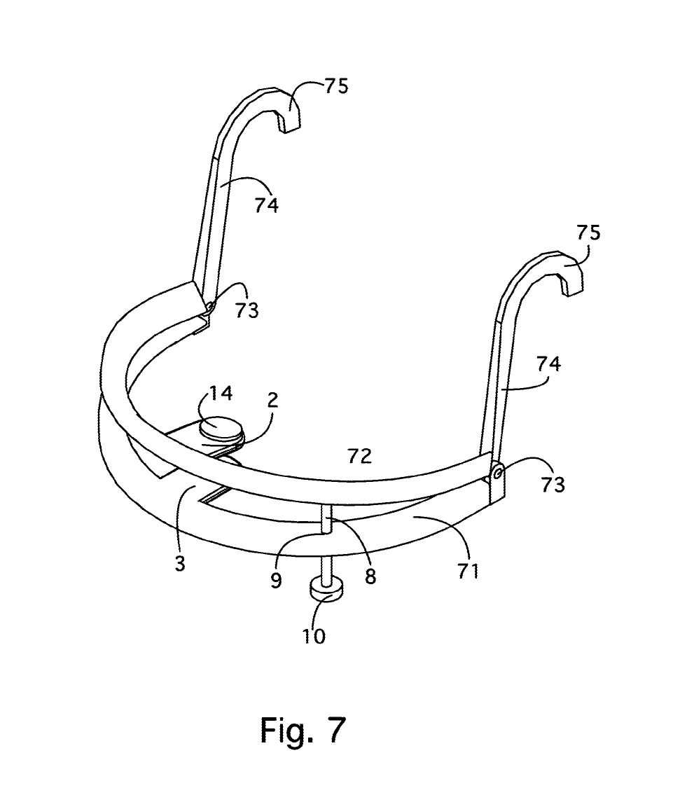

FIG. 7 shows a further preferred embodiment according to the present invention.

FIG. 1 shows a first preferred embodiment according to the present invention. Shown in this figure is a jaw muscle stretcher 1 for obtaining a result envisaged according to the present invention of relaxing the jaw muscles by stretching thereof. The device comprises two treatment elements 2, 3 for placing thereof between the lower jaw and the upper jaw of a person. The surfaces 4, 5 can be placed for this purpose between the respective upper teeth and lower teeth of the person. Provided for protection of the teeth is a protective layer or a protective part 14 arranged on the outer side of the treatment elements. Such a part is preferably provided with a relatively soft plastic or rubber.

For the purpose of urging treatment elements 2, 3 apart they are mutually coupled by means of a lower frame part 7 and an upper frame part 6. Lower frame part 7 is constructed of vertical slide elements 11, 13, and upper frame part 6 comprises vertical slide elements 12, 16. The lower slide elements slide inside the upper slide elements. The treatment elements can hereby be moved relative to each other in the longitudinal direction of the slide elements. A rod 8 provided with screw thread pushes against bridge 15 of upper frame element 6. Arranged in a through-opening 9 of lower frame part 7 is a screw thread corresponding to the screw thread of rod 8. By rotating knob 10 in the direction corresponding to the screw thread the lower frame part can be moved in the direction of arrow A relative to the upper frame part.

FIG. 2 shows schematic side views of three further preferred embodiments according to the present invention. The variant of FIG. 2A has a presetting wherein the lower treatment element 3 can be placed at a number of positions in lower frame part 7. A wide range D between the treatment elements can hereby be realized with a relatively small screw thread displacement. In order to obtain this wide range the user first selects a presetting by correct placing of the lower treatment element 3 relative to lower frame part 7, after which the treatment is performed by rotating the screw thread by means of knob 10. In this variant a relatively thick spindle 8 provided with screw thread is screwed out of the lower frame part. A masking plate 17 is preferably further provided for masking the mouth when it is in the unattractive open position.

In the variant of FIG. 2B the displacement between frame parts 6 and 7 is realized by means of air pressure. The air pressure is developed by means of air pump 21 which can be operated by means of manual force by squeezing thereof. The airflow between the frame parts and the air pump can be closed by means of a valve 22. The air pump can also be a motorized variant. Both variants can be controlled on the basis of air pressure by means of a sensor.

In the variant of FIG. 2C a further air pressure variant, like that of FIG. 2B, is a relatively small embodiment variant wherein the frame parts 6 and 7 can be placed as a whole between the upper and lower jaws. The device hereby takes a very compact form.

The essence of the invention is that the upper jaw and the lower jaw can be pushed apart under pressure. The drive part can be embodied in many mechanical ways. It is recommended here that the device can be taken out of the mouth, between the two jaws, in any position. For this purpose the angle between the elements which contact the teeth is preferably such that during removal the surface is not an obstacle.

Instead of a knob 10 in a straight position it is possible to provide a knob 10′ as according to FIG. 3. The angle of operation for the user can hereby be placed in a different orientation. A swivel joint 31 is then arranged between the spindle and the knob in order to enable the driven angle. An alternative to the universal joint is a toothed wheel arranged on the underside of shaft 8 and driven by means of a knob 10″ and a worm wheel 42. A further alternative to knob 10 is a screw 51 which is arranged in a treatment element 3 and which is provided on the inner side with a screw thread corresponding to the screw thread of shaft 8. The shaft can hereby be rotated similarly to the embodiment according to FIG. 1.

FIG. 6 shows four further variants. These variants function on the basis of a pivot principle. In FIG. 6A this operates as follows. Two arms 61, 62 having at the end of the arms treatment elements 2, 3 arranged pivotally by means of hinges 66 pivot relative to a hinge 63. It is hereby possible to urge the treatment elements apart relative to each other. In the variant of FIG. 6B the pivot arms are extended with handles, as in the case of pliers. Force can hereby be exerted in the direction of arrow A so that treatment elements 2, 3 are forced apart. A brake element 67 ensures that during treatment the stretched state can be temporarily held in place. The variant of FIG. 6 has two arms which are pressed apart by means of a triangular element 69 by means of the spindle driven with knob 10. A frame 68 has an opening 9 with a screw thread corresponding to that of the spindle. The arms are pivotable relative to frame 68 by means of hinges 70.

FIG. 7 shows a further preferred embodiment, the treatment elements 2, 3 of which can be placed in the mouth. These treatment elements are mounted on the respective arcuate support members 71, 72 which are attached to each other by means of hinges 73. Provided in this preferred embodiment for the spreading function is a screw 8 which pushes the lower support member 71 in the direction of arrow A away from the upper support member 72. A through-opening 9 in the lower support member has a screw thread here corresponding to that of screw 8. For user convenience this preferred embodiment is provided with ear supports 74, 75 extending upward from the upper support member 72. This device is therefore intended for placing on the outer side of both jaws with hinges 73 substantially on either side of both maxillary joints.

The present invention has been described in the foregoing on the basis of several preferred embodiments. Different aspects of different embodiments are deemed described in combination with each other, wherein all combinations which can be deemed by a skilled person in the field as falling within the scope of the invention on the basis of reading of this document are included. These preferred embodiments are not limitative for the scope of protection of this document. The rights sought are defined in the appended claims.

1. A device for stretching the jaw muscle and/or preventing consequences of bruxism, such as TMJD, wherein the device comprises:
a lower engaging member with a stimulus surface directed substantially downward during use for providing an engagement on a lower jaw element or the teeth thereof during performing of the treatment;
an upper engaging member with a stimulus surface directed substantially upward during use for providing an engagement on an upper jaw element or the teeth thereof during performing of the treatment;
a mechanism connecting the lower engaging member and the upper engaging member for providing a mutual connection between the engaging members,
and a drive mechanism for moving apart at least parts of the engaging members by means of a driving for the purpose of forcing apart the lower jaw element and the upper jaw element, thereby achieving that at least the muscles of mastication are exposed to an activation stimulus.

2. The device as claimed in claim 1, wherein the relative orientation during the movement of moving apart the engaging members is such that the engaging members are directly removable from the mouth in this relative orientation to each other.

3. The device as claimed in claim 1, wherein the relative orientation during the movement of moving apart the engaging members is such that the respective stimulus surfaces are always arranged at an angle such that imaginary lines extending from the stimulus surfaces would intersect each other behind the person, or that these imaginary lines have a parallel progression.

4. The device as claimed in claim 1, wherein the connecting mechanism is adapted for a linear movement of the engaging members relative to each other.

5. The device as claimed in claim 3, wherein the connecting mechanism is adapted for a pivoting movement of the engaging members relative to each other.

6. The device as claimed in claim 3, wherein the connecting mechanism is provided with a hinge arranged during use on the front side of the head of a user.

7. The device as claimed in claim 3, wherein the connecting mechanism is provided with one or more hinges defining a rotation axis of a hinge substantially close to the pivot axis of the maxillary joint of the user.

8. The device as claimed in claim 1, wherein the upper stimulus surface has an inclining surface directed substantially downward during use and/or the lower stimulus surface has an inclining surface directed substantially upward during use.

9. The device as claimed in claim 1, wherein the stimulus surface is formed by a material which does not affect the teeth, such as material which is less hard than the teeth, preferably a soft plastic material or a soft rubber material.

10. The device as claimed in claim 1, wherein the connecting mechanism is provided with a drive by means of a screw thread.

11. The device as claimed in claim 1, wherein the connecting mechanism is provided with a pneumatic or hydraulic drive, more preferably by means of a drive with an electric motor.

12. The device as claimed in claim 1, further comprising a measuring assembly for providing measurement data relating to the mutual distance between the stimulus surfaces, which measuring assembly is preferably optically readable and which measuring assembly more preferably comprises electronic and/or optical measuring means.

13. The device as claimed in claim 1, further comprising means for providing a visual and/or auditive signal relating to the mutual distance between the stimulus surfaces, such as a limit value thereof, to the user.

14. The device as claimed in claim 1, further comprising a stop adjustable prior to the treatment.

15. The device as claimed in claim 14, wherein the stop is formed by two screw elements.

16. The device as claimed in claim 1, further comprising a measuring member for measuring the force exerted by the stimulus surfaces on the upper jaw and the lower jaw.

17. The device as claimed in claim 1, further comprising a masking member for masking the opening of the mouth during use.

18. The device as claimed in claim 1, further comprising means for coupling the device to the ears of the treated person.

19. A method for performing a treatment for the purpose of providing a relaxed expression by providing an activation stimulus to a facial muscle making use of a device as claimed in one or more of the foregoing claims, wherein the method comprises steps for:
placing the stimulus surfaces at a relatively small mutual distance between the lower jaw and the upper jaw;
activating the connecting mechanism in order to increase the mutual distance between the stimulus surfaces;
maintaining for a short period of time the mutual distance obtained through the activation; and
activating the connecting mechanism in order to decrease the mutual distance between the stimulus surfaces.

20. The method as claimed in claim 19, comprising steps for repeating said steps.
